(19) United States
(12) Patent Application Publication
(10) Pub. No.: US 2013/0314541 A1
(43) Pub. Date: Nov. 28, 2013

(54) METHODS AND ARRANGEMENTS FOR OBJECT POSE ESTIMATION

(71) Applicant: Digimarc Corporation, (US)

(72) Inventors: John D. Lord, West Linn, OR (US); Alastair M. Reed, Lake Oswego, OR (US)

(73) Assignee: Digimarc Corporation, Beaverton, OR (US)

(21) Appl. No.: 13/863,897

(22) Filed: Apr. 16, 2013

Related U.S. Application Data
(60) Provisional application No. 61/624,815, filed on Apr. 16, 2012.

(51) Int. Cl. G06T 7/00

(52) U.S. Cl. CPC G06T 7/004
USPC 348/150

(57) ABSTRACT

In an illustrative embodiment, the free space attenuation of illumination with distance, according to a square law relationship, is used to estimate the distance between a light source and two or more different areas on the surface of a product package. By reference to these distance estimates, the angular pose of the object surface is determined.

### RELATED APPLICATION DATA

The present application claims priority to provisional application 61/624,815, filed Apr. 16, 2012.

### TECHNICAL FIELD

The present technology concerns estimating the pose of an object relative to a camera, such as at a supermarket checkout.

INTRODUCTION AND SUMMARY

Pending patent applications Ser. No. 13/231,893, filed Sep. 13, 2011 (published as US20130048722), Ser. No. 13/750,752, filed Jan. 25, 2013, and No. 61/544,996, filed Oct. 7, 2011, detail various improvements to supermarket checkout technology. In some aspects, those arrangements concern using a camera at a checkout station to read steganographically-encoded digital watermark data encoded in artwork on product packaging, and using this information to identify the products.

One issue addressed in these prior patent applications is how to determine the pose of the object relative to the camera. Pose information can be helpful in extending the off-axis reading range of steganographic digital watermark markings. The present technology further addresses this issue.

In accordance with one aspect of the present technology, the free space attenuation of illumination with distance, according to a square law relationship, is used to estimate the distance between a light source and two or more different areas on the surface of a product package. By reference to these distance estimates, the angular pose of the object surface is determined.

The foregoing and other features and advantages of the present technology will be more readily apparent from the following detailed description, which proceeds with reference to the accompanying drawings.

### BRIEF DESCRIPTION OF THE DRAWINGS

FIG. 1 shows an object being illuminated by a light source and imaged by a camera, where the object surface is perpendicular to the axis of the camera.

FIG. 2 is similar to FIG. 1, but shows the situation when the object surface is inclined relative to the axis of the camera.

FIG. 3 shows two spaced apart regions on a cereal box that are determined to be free of black ink printing.

FIG. 4 is an expanded excerpt of FIG. 2.

### DETAILED DESCRIPTION

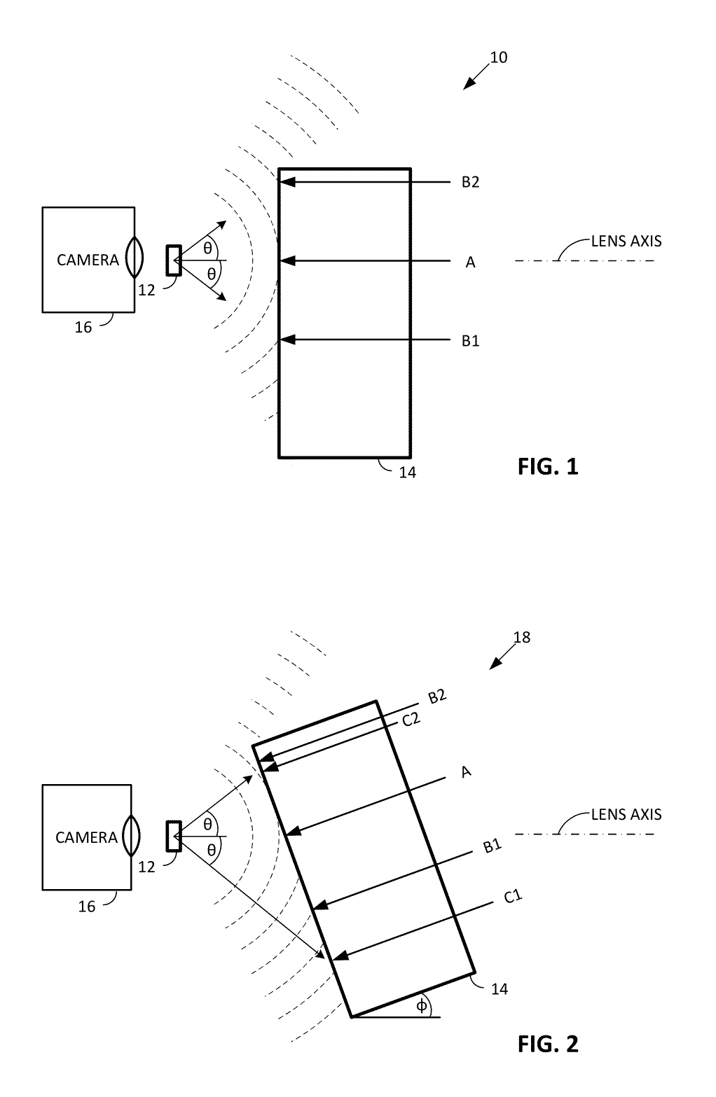

FIG. 1 shows an arrangement 10 (e.g., looking from above down from above a supermarket checkout station) in which a light source 12 illuminates an object 14. A camera 16 captures imagery of the illuminated object through a lens. (The light source is positioned as close as practical to the lens axis of the camera, but not so as to obscure the camera's view.)

The light source 12 desirably approximates a point source. A light emitting diode (LED) is suitable. The LED may be unpackaged, and without an integrated lens. Such a light source produces spherical wavefronts having uniform power density at all illuminated angles (i.e., until masking by the light source mounting arrangement blocks the light).

The object 14 may be, e.g., a cereal box.

As shown in FIG. 1, the light power density falling on the object 14 is at a maximum at point A (the point closest to the source 12), with the illumination falling off at other points on the object surface. If the surface normal at point A passes through the light source, as shown, then two points on the object surface that are the same distance from point A (e.g., points B1 and B2) will be equally illuminated. Indeed, all points on the object surface that are equally distant from point A are equally illuminated. Put another way, all points lying on the surface of object 14 that are a given angle θ off-axis from the camera lens, are equally illuminated.

The illumination strength at any point is a function of distance from the light source, according to a square law relationship. That is, the power emitted by the light source is distributed over the spherical wavefront. The surface area of this wavefront increases with distance from the source per the formula 4*Pi*d² (where d is distance), causing the power per unit surface area to diminish accordingly.

In the illustrated example, angle θ is about 38 degrees. The distance between the light source and point B1 is thus about 1.26 times the distance between the light source and point A (i.e., 1/cosθ). Accordingly, the light power density at point B1 (and at point B2) is about 62% of the light power density at point A.

Consider, now, the arrangement 18 shown in FIG. 2. Here, object 14 is inclined by an angle φ relative to the lens axis of the camera 16.

In this case, points on the surface of object 14 that are uniformly spaced from point A (i.e., points B1 and B2) are not equally illuminated. Similarly, points lying on the surface of object 14 that are a given angle θ off-axis from the camera lens (i.e., points C1 and C2) are not equally illuminated.

By comparing the light power density at a patch of pixels around point C1, relative to the light power density at a patch of pixels around point A (or point C2), the inclination angle φ of the object 14 can be determined.

As just-indicated, the light power density on the surface is indicated by the pixel values produced by the camera 16. These pixel values will additionally be a function of the printing and artwork on the box. For example, if the box is printed with a dark color of ink, less light will be reflected to the camera, and the pixel values output by the camera will be commensurately reduced.

To reduce the effect of inked object printing on the reflected light sensed by the camera, illumination and sensing at near-infrared is desirably used. Conventional cyan, magenta and yellow printing inks are essentially transparent to near-infrared, so an infrared-sensitive camera 16 sees-through such inks to the base substrate. The base substrate is generally uniform in reflectivity, so the light reflected from the substrate is essentially a function of the distance from the light source 12, alone.

Black ink, however, is not near-infrared transparent. Its treatment is discussed below.

Near infrared is generally considered to be those wavelengths just beyond the range of human perception, e.g., 750 nanometers and above. Far infrared, in contrast, is generally regarded to start at 15 μm. Near infrared LED sources are commonly available (e.g., the Epitex L810-40T52 810 nm LED, and the Radio Shack 940 nm LED), as are infrared-sensitive cameras.

An illustrative method proceeds as follows:

Illuminate the object using near-IR. Illumination closer to the object is preferable than more distant illumination, since the square-law variation across inclined surfaces will then be greater. As noted, near-IR avoids color ink effects, and helps retain a relatively uniform reflectance over an object.

Capture monochrome image data with the camera.

For a point on a normal plane surface, the image brightness drops off with the inverse square of the light-to-object-to-camera distance. So for a surface at an angle to the camera/illumination axis (assuming no specular reflectance), the brightness will vary according to distance. (As discussed above in connection with FIG. 1, this variation will also be observed in the periphery of a flat normal surface.)

The amount of brightness change for a unit change in distance is a function of absolute distance (the inverse square relationship). A gently sloped surface that's close will have a similar intensity gradient as a steeply sloped surface that's farther away.

One method to distinguish these two cases is to pre-calculate this brightness drop-off function, and fit a histogram of the image brightness to it, to estimate the object distance. Then this estimated distance is used as a parameter in the projection estimation.

A next step in this exemplary procedure is to generate a histogram of the image pixel values. Delete from the histogram all completely black pixels (or pixels with illumination below a threshold that corresponds to no object in the field of view). Think of this as camera flash guide numbers, camera ISO, and flash range. We care only about the object that's within useful depth range for our camera system. (Note: a range of exposures with different flash intensities can help in distance estimation too.) Similarly, remove any unusually bright points from the histogram.

Fit the remaining image brightness histogram to the pre-calculated brightness drop-off function, to get an estimate of object distance. We can assume uniform grey or some empirically derived grey level depending on typical object material reflectance for the lighting used and camera ISO.

For patches of image pixels arranged in a grid, estimate the average image brightnesses. Apply an estimated correction to these using the overall image brightness histogram and the above-noted inverse-square function.

Then calculate a projective transform for each region of the image to be examined, possibly combining multiple patches to filter for object reflective variations from printing, etc. The camera and optical system is known (specific focal length, sensor size, etc.) for the calculation.

Once the projective transform for a patch of image pixels has thereby been estimated, geometrically correct the patch of image pixels to virtually re-project onto a plane normal to the camera axis. This corrected patch of image pixels is then passed to the steganographic watermark decoder for decoding.

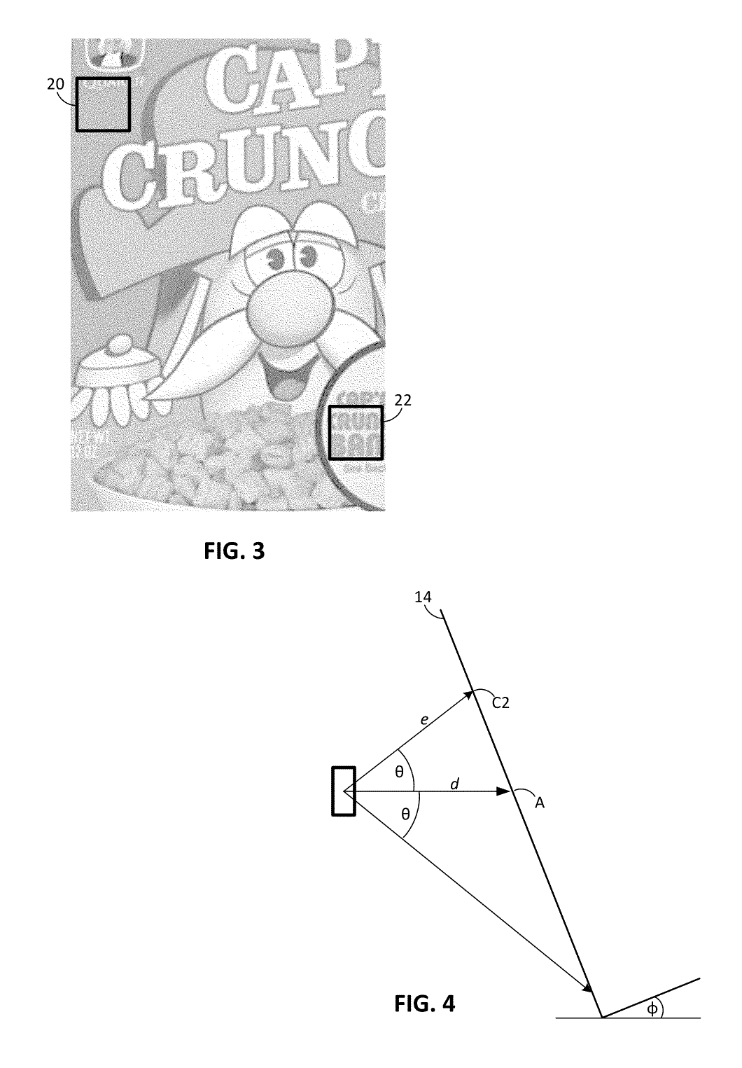

As noted, black ink is not transparent to near IR illumination; it absorbs such illumination, resulting in a darkening of the corresponding pixels. To address this problem, the presence of black ink markings can be sensed by local variation in reflectance from the object—which is uncharacteristic of reflectance from the underlying substrate. Various image busyness metrics can be applied for this purpose. One is to measure the standard deviation of the image patch. Alternatively an edge detector, like Canny can be used. After application of such a black ink-discriminating process, two or more spaced-apart regions on the object can be identified, and corresponding excerpts of the pixel data (e.g., 20 and 22 in FIG. 3) can be used in determining the object pose.

FIG. 4 is an enlarged excerpt from FIG. 2. The average illumination around point C2 is determined from the captured camera data. Likewise for the average illumination around point A. The distance “d” from the light source to point A on the object is estimated from the brightness of the imagery captured from a region around point A (e.g., per the histogram fitting arrangement described above). The analysis then estimates the distance “e” from the light source to point C2 by reference to the two average illumination values, and by angle θ (38 degrees in this example, which corresponds to pixel offset from the center of the image frame, per a lens function).

In the illustrated example, the average illumination around point C2 is 95% that around point A. This indicates that distance “e” is about 97.5% of distance “d.” If distance “d” is brightness-estimated to be 6 inches, then distance “e” is 5.85 inches. In the illustrated case, with an angle θ of 38 degrees between a horizontal base of 6 inches, and a side “e” of 5.85 inches, geometrical analysis indicates angle φ has a value 20 degrees.

Thus, in this case, the imagery captured from the camera is virtually re-projected to remove this 20 degree perspective aspect, to yield a set of processed data link that which would be viewed if the surface of object 14 were perpendicular to the camera. A watermark decoding operation is then applied to the re-projected image data.

### Concluding Remarks

Having described and illustrated the principles of our technology with reference to an exemplary embodiment, it will be recognized that the technology is not so limited.

For example, while a point source—which generates spherical wavefronts of uniform power density—is illustrated, this is not essential. An alternative is to use a light source that does not have uniform illumination at all angles. The illumination strength as a function of off-axis angle (which may be in two dimensions) can be measured or estimated. The effects of such illumination can then be corrected-for in the analysis of object pose estimation.

Similarly, it is not necessary that the light source be positioned near the axis of the camera. Again, other arrangements can be employed, and the differences in object surface illumination due to such placement can be measured/estimated, and such effects can be corrected-for in the analysis of object pose estimation.

While illustrated in the context of a planar object surface, it will be recognized that the same principles can likewise be applied with curved object surfaces.

Similarly, while described in connection with determining the inclination angle in one dimension (e.g., horizontally), the same principles can likewise be used to find the inclination angles in more than one dimension (e.g., horizontally and vertically).

Likewise, while described in the context of reading digital watermark indicia, such pose determination methods are also applicable to object identification by other means, such as by barcode reading, fingerprint-based identification (e.g., SIFT), etc.

Digital watermark technology is detailed, e.g., in Pat. No. 6,590,996 and in published application 20100150434.

Patent application Ser. No. 13/088,259, filed Apr. 15, 2011 (published as 20120218444), details other pose estimation arrangements useful in watermark-based systems.

In the interest of conciseness, the myriad variations and combinations of the described technology are not cataloged in this document. Applicant recognizes and intends that the concepts of this specification can be combined, substituted and interchanged—both among and between themselves, as well as with those known from the cited prior art. Moreover, it will be recognized that the detailed technology can be included with other technologies—current and upcoming—to advantageous effect.

To provide a comprehensive disclosure, while complying with the statutory requirement of conciseness, applicant incorporates-by-reference each of the documents referenced herein. (Such materials are incorporated in their entireties, even if cited above in connection with specific of their teachings.) These references disclose technologies and teachings that can be incorporated into the arrangements detailed herein, and into which the technologies and teachings detailed herein can be incorporated. The reader is presumed to be familiar with such prior work.

We claim:

1. A method comprising:
illuminating an object at a supermarket checkout station;
capturing image data from the illuminated object;
identifying two spaced-apart regions on the object; and
by reference to excerpts of the captured image data corresponding to said two spaced-apart regions, determining pose information for the object.

2. The method of claim 1 in which the illuminating comprises illuminating the object with infrared illumination.

3. The method of claim 1 in which the identifying comprises identifying two spaced-apart regions on the object that are free of black ink printing.

4. The method of claim 3 in which the identifying comprises applying a busyness metric to identify two spaced-apart regions that are free of black ink printing.

5. A supermarket scanning system including an infrared illumination source, a processor and a memory, the memory containing programming instructions that configure the system to perform acts including:
illuminating an object with infrared illumination;
capturing image data from the illuminated object;
by reference to the captured image data, identifying two spaced-apart regions on the object that are free of black ink printing; and
by reference to excerpts of the captured image data corresponding to said two spaced-apart regions, determining pose information for the object.

6. A computer readable medium containing programming instructions that configure a supermarket scanning system that includes an infrared illumination source to perform acts including:
illuminating an object with infrared illumination;
capturing image data from the illuminated object;
by reference to the captured image data, identifying two spaced-apart regions on the object that are free of black ink printing; and
by reference to excerpts of the captured image data corresponding to said two spaced-apart regions, determining pose information for the object.
